(19) United States
(12) Patent Application Publication
(10) Pub. No.: US 2026/0274213 A1
(43) Pub. Date: Sep. 17, 2026

(54) SYSTEM AND METHOD FOR AUTOMATED VEHICLE REFUELING AT REFUELING STATIONS

(71) Applicant: Torc Robotics, Inc., Blacksburg, VA (US)

(72) Inventors: Ajay Tulsyan, Austin, TX (US); . Raghav, Montreal (CA); Savio Pereira, Austin, TX (US)

(21) Appl. No.: 19/080,416

(22) Filed: Mar. 14, 2025

(51) Int. Cl. B60S 5/02; B60W 60/00; B67D 7/04; E05F 15/603; E05F 15/73

(52) U.S. Cl. CPC B60S 5/02; B60W 60/001; B67D 7/0401; E05F 15/603; E05F 15/73; B60W 2420/403; B60W 2530/209; B60W 2552/10; B60W 2552/53; B67D 2007/0474; E05F 2015/767; E05Y 2900/534

(57) ABSTRACT

A system and method for automated refueling of an autonomous vehicle are described. The autonomous vehicle includes at least one sensor and a processing device communicatively connected to the at least one sensor. The method includes executing instructions stored in a memory with a processing device in communication with the one or more sensors to perform operations. The operation include detecting, using an input from the fuel sensor, when a remaining fuel level for the autonomous vehicle is less than a threshold fuel level, identifying a refueling station for refueling of the autonomous vehicle, controlling the navigation of the autonomous vehicle to locate the autonomous vehicle at the identified refueling station, and further controlling the navigation of the autonomous vehicle to locate the autonomous vehicle in an alignment lane at the identified refueling station.

### TECHNICAL FIELD

The field of the disclosure relates to vehicle refueling and, in particular, to a system and method for automated vehicle refueling at refueling stations.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

In some cases, autonomous vehicles are powered solely by an internal combustion engine. In other cases, autonomous vehicles may be powered by a hybrid system comprised of a combination of an internal combustion engine and one or more electric motors that use energy stored in batteries. Autonomous vehicles that are powered either by an internal combustion engine, either as the single source of power to the vehicle or in combination with electric motors in a hybrid system, consume fuel from a fuel reservoir or tank to power the internal combustion engine. Once the fuel within the fuel reservoir is near depletion, the autonomous vehicle will be required to stop for refueling. In many cases, these stops will occur at a refueling station, such as a gas station.

Typically, refueling at a refueling station requires a station attendant or the vehicle driver to manually connect a fuel supply nozzle associated with a fuel dispenser to a reservoir inlet of a fuel reservoir for the vehicle. The vehicle driver or service station attendant then manually operates a handle on the fuel supply nozzle to enable the flow of fuel into the fuel reservoir from the fuel dispenser. Most frequently, the vehicle driver is the person who manually operates the fuel nozzle to fill the vehicle's fuel reservoir. However, the fundamental technologies employed by autonomous vehicles allow the autonomous vehicles to operate without a driver who is able to perform these actions to refuel autonomous vehicles.

Additionally, refueling stations rarely employ gas station attendants who can manually connect the fuel nozzle to the reservoir inlet and operate the handle to dispense fuel to autonomous vehicles. Without a driver in the vehicle or a gas station attendant, autonomous vehicles arriving at refueling stations would not have a person to complete the autonomous vehicle refueling. This may affect the ability of the autonomous vehicles to complete their mission in a timely and efficient manner.

Accordingly, there exists a need for solutions that allow for efficient refueling of autonomous vehicles at refueling stations without the need for manual intervention or additional resources. These and other needs are met by the exemplary systems and methods for automated vehicle refueling at refueling stations as discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a method for automated refueling of an autonomous vehicle is described. The autonomous vehicle comprising at least one sensor and a processing device communicatively connected to the at least one sensor. The method comprising executing instructions stored in a memory with a processing device in communication with the one or more sensors to perform operations. The operation comprising detecting, using an input from the fuel sensor, when a remaining fuel level for the autonomous vehicle is less than a threshold fuel level, identifying a refueling station for refueling of the autonomous vehicle, controlling the navigation of the autonomous vehicle to locate the autonomous vehicle at the identified refueling station, and further controlling the navigation of the autonomous vehicle to locate the autonomous vehicle in an alignment lane at the identified refueling station.

In another aspect, a system for automated refueling of autonomous vehicles is described. The system includes one or more refueling stations. Each refueling station includes at least one automated fuel dispenser configured to dispense fuel during refueling of vehicles. The system also includes at least one autonomous vehicle each comprising a fuel sensor and a processing device in communication with the fuel sensor. Each processing device is configured to execute instructions stored in a memory to perform operations. The operations include detecting, using an input from the fuel sensor, when a remaining fuel level for an autonomous vehicle is less than a threshold fuel level, identifying at least one candidate refueling station from the one or more refueling stations, selecting a preferred refueling station from the at least one candidate refueling station, controlling the navigation of the autonomous vehicle to locate the autonomous vehicle at the identified refueling station, and further controlling the navigation of the autonomous vehicle to locate the autonomous vehicle in an alignment lane at the identified refueling station.

In yet another aspect, a method for automated refueling of an autonomous vehicle is described. The autonomous vehicle comprises at least one sensor and a processing device communicatively connected to the at least one sensor. The method comprises executing instructions stored in a memory with the processing device to perform operations. The operations comprise detecting, based on an input from the at least one sensor, a fuel nozzle of an automated fuel dispenser in proximity to the autonomous vehicle, determining a location of the fuel nozzle relative to a reservoir inlet for the autonomous vehicle while the fuel nozzle is automatically extended towards the autonomous vehicle by the automated fuel dispenser, and actuating a prime mover to automatically open an outer cover of the reservoir when the location of the fuel nozzle is within a threshold distance of the reservoir inlet. The method further comprises receiving the fuel nozzle in the reservoir inlet to create a fluidic connection between the fuel reservoir and the fuel nozzle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous vehicle.

FIG. 2 is a schematic perspective view of an autonomous vehicle.

FIG. 3 is a schematic side view of an autonomous vehicle.

FIG. 4 a block diagram of the autonomous vehicle shown in FIGS. 1-3;

FIG. 5 is a block diagram of an example computing system;

FIG. 6 is a schematic perspective view of an automated fuel dispenser;

FIG. 7 is a perspective view of a refueling station including two automated fuel dispensers.

FIG. 8 is a block diagram of an exemplary system for automated refueling of autonomous vehicles.

FIG. 9 is a flowchart of an exemplary method for automated refueling of autonomous vehicles.

FIG. 10 is a flowchart of an exemplary method for aligning an autonomous vehicle for automated refueling of the autonomous vehicle.

FIG. 11 is a flowchart of an exemplary method for automated refueling of autonomous vehicles.

FIG. 12 is a flowchart of an exemplary method for automated refueling of autonomous vehicles.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary systems and methods for automated vehicle refueling at refueling stations allow autonomous vehicles to refuel without the need for intervention by a human using an automated fuel dispenser. For example, the exemplary systems and methods allow autonomous vehicles to automatically identify a fuel station for refueling and navigate to the fuel station. Additionally, the exemplary systems and methods allow an autonomous vehicle to position and align itself to use an automated fuel dispenser located at the fuel station. The exemplary systems and methods also allow the automated fuel dispenser to automatically connect a fuel nozzle with the fuel inlet of the autonomous vehicle to refuel the autonomous vehicle.

The exemplary systems and methods rely on sensors of the autonomous vehicle to monitor the surrounding environment around the vehicle and automatically position the autonomous vehicle for refueling by an automated fuel dispenser. The sensor data can also be used to determine a location of fuel nozzle for the automated fuel dispenser. Additionally, the exemplary systems and methods therefore rely on sensors of the automated fuel dispenser to monitor the surrounding environment around the automated fuel dispenser and detect when an autonomous vehicle is in position for refueling. The sensor data can be used to determine a location of a reservoir inlet. The automated fuel dispenser can adjust a position of the fuel nozzle based on the location of the reservoir inlet and automatically connect the fuel nozzle to the reservoir inlet and refuel the autonomous vehicle without the need for human intervention.

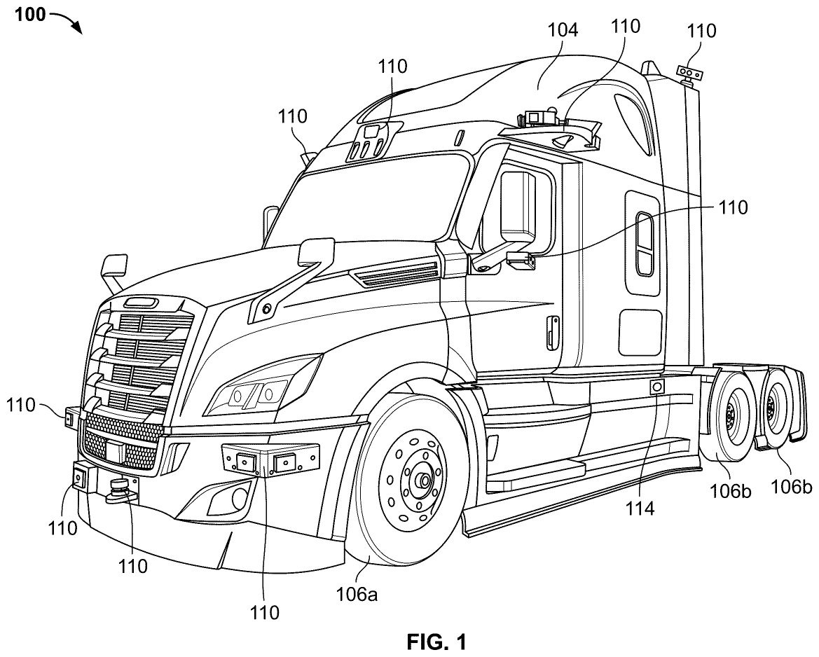

Various embodiments in the present disclosure are described with reference to FIGS. 1-12 below.

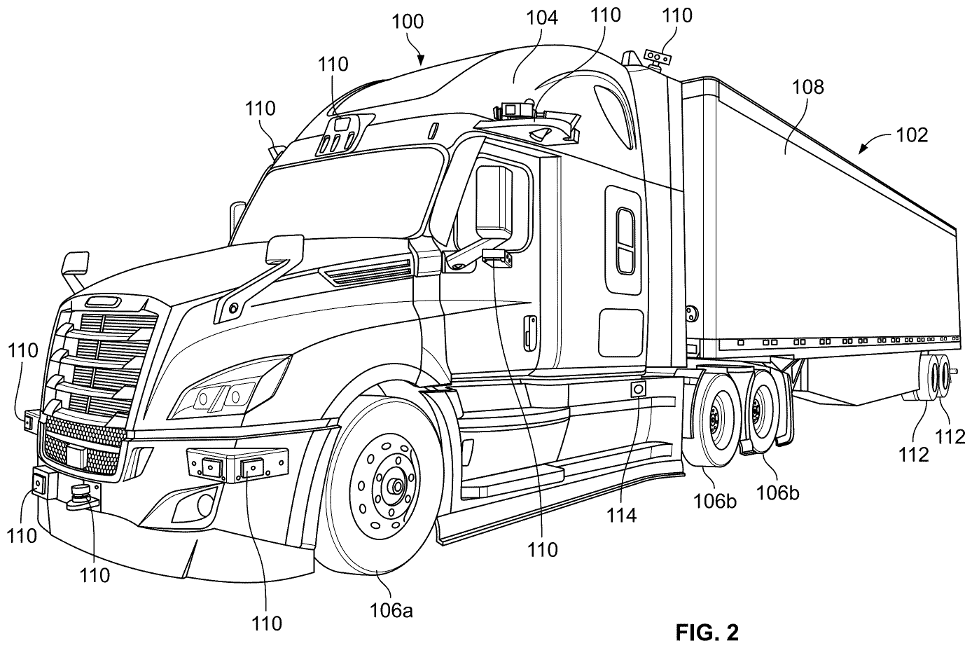

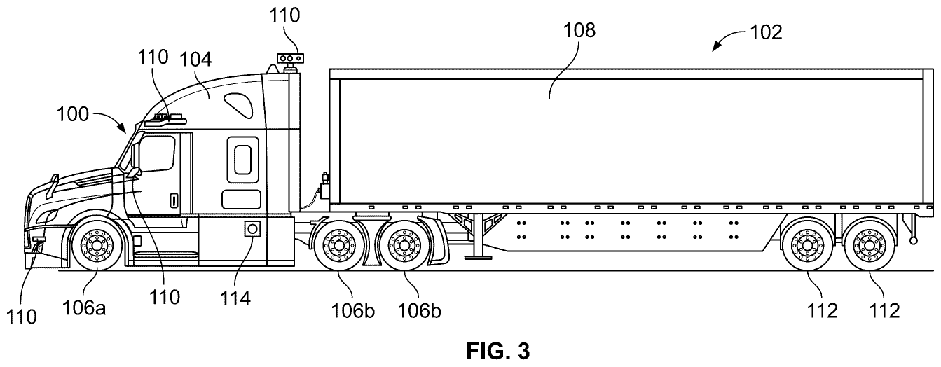

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

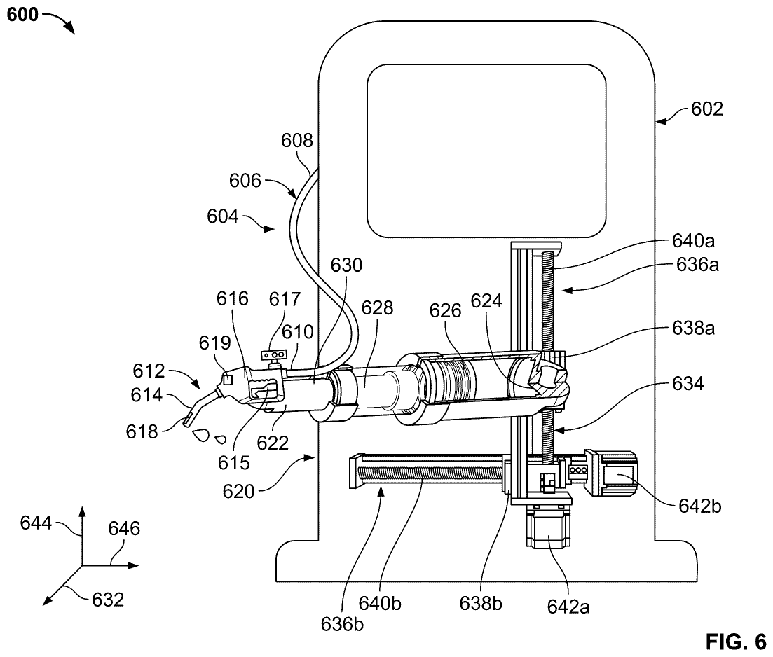

Additionally, the vehicle 100 includes a reservoir inlet 114 positioned on the vehicle 100 to receive a fuel nozzle from a fuel dispenser, such as fuel nozzle 612 from automated fuel dispenser 600 (shown in FIG. 6). The reservoir inlet 114 is used to create a connection, such as a fluid connection, between the fuel nozzle and a vehicle fuel reservoir (not shown) to enable the vehicle fuel reservoir to receive fuel from the fuel dispenser using the fuel nozzle to refuel the vehicle 100. The vehicle fuel reservoir is configured to store fuel for consumption by the vehicle during operation of the vehicle 100.

The reservoir inlet 114 includes an outer cover (not shown) configured to actuate between an open position and a closed position to allow access to the reservoir inlet 114. When the outer cover is in the open position, the reservoir inlet 114 may be allowed to receive a fuel nozzle (e.g., fuel nozzle 612 shown in FIG. 6) to create the flow connection between the fuel nozzle and the vehicle fuel reservoir. When the outer cover is in the closed position, the outer cover may prevent access to the reservoir inlet 114 by, for example, a fuel nozzle, environmental debris, or the like. The outer cover may be automatically actuated by a prime mover, such as a motor (not shown) for example, between the open and closed positions, as described herein. In an embodiment, the motor may be a stepper motor, but is not limited thereto.

Additionally, the reservoir inlet 114 nay include an inner lid (not shown). The inner lid may be biased into a closed position to maintain protection of the reservoir inlet 114 when a fuel nozzle spout is not positioned in the reservoir inlet. In an embodiment, the inner lid may be made of a rubber material or a silicone material, but is not limited thereto. In some embodiments, the inner lid may include an inlet reference marker. The inlet reference marker may allow sensors (e.g., sensor 617) to identify a specific reference point on the inner lid. The inlet reference marker may be a piece of material positioned on the inner lid or a symbol made on the inner lid that provides high contrast from portions of the inner lid surrounding the inlet reference marker.

The vehicle 100 includes at least one fuel level sensor (not shown) positioned within the fuel reservoir, such as fuel sensor 208 (shown in FIG. 2), configured to measure a fuel level within the vehicle fuel reservoir and communicate the fuel level with a processing device (e.g., computing system 200, computing system 300, or the like) for autonomous vehicle 100. Once the fuel stored within the vehicle fuel reservoir is consumed, the vehicle 100 may need to refuel to refill the vehicle fuel reservoir to continue operation for the vehicle 100.

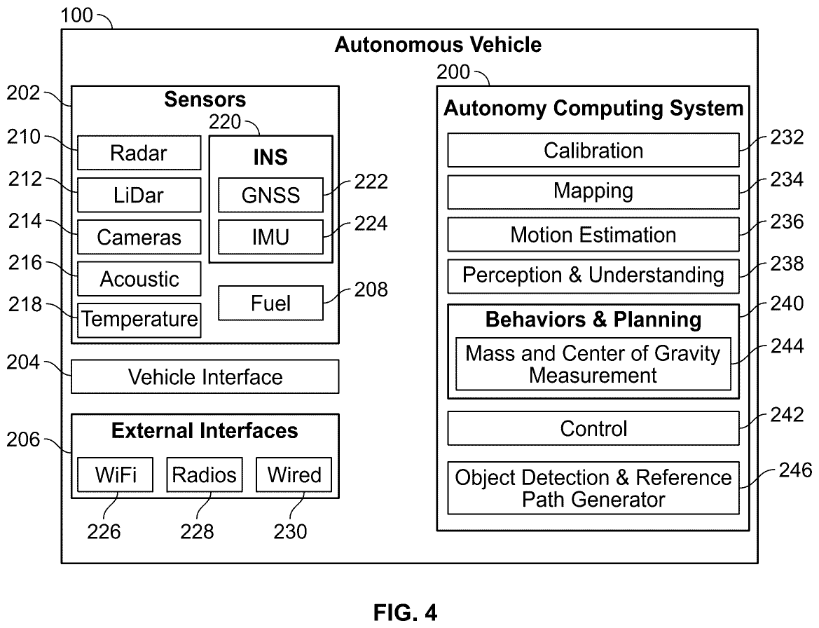

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 208-220 shown in FIG. 4 and described herein.

In the example embodiment, sensors 202 may include various sensors such as, for example, fuel sensors 208, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Fuel sensors 208 are configured to measure a level of fuel within a fuel reservoir of the autonomous vehicle 100. In an embodiment, the at least one fuel sensor 208 may be one of a float fuel sensor, a capacitive fuel, and an ultrasonic fuel sensor, but is not limited thereto. The at least one fuel sensor 208 is configured to communicate a signal indicating the fuel level to the autonomy computing system 200.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 230, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 232, a mapping module 234, a motion estimation module 236, a perception and understanding module 238, a behaviors and planning module 240, a mass and center of gravity measurement module 244, a control module or controller 242, and an object detection and reference path generator module 246. The object detection and reference path generator module 246, for example, may be embodied within another module, such as behaviors and planning module 240, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

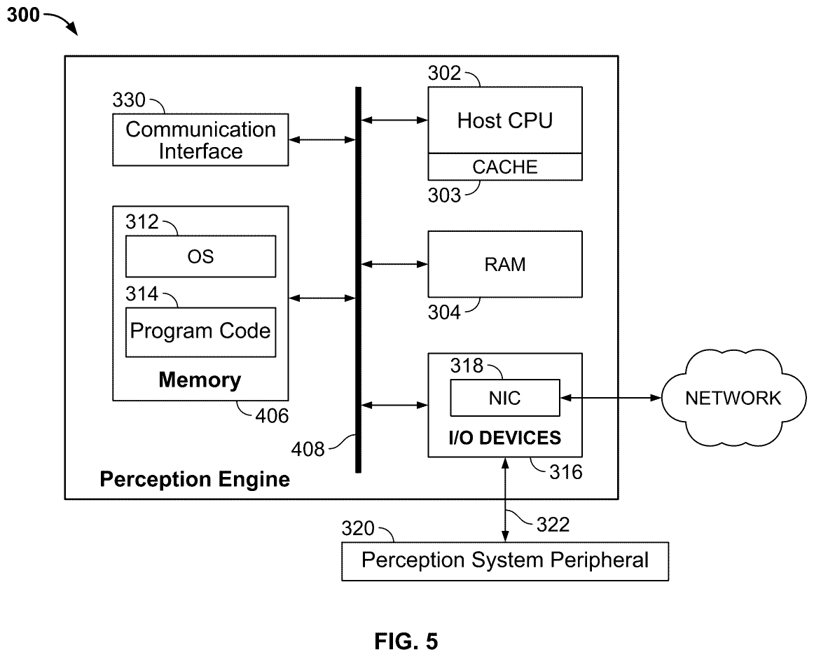

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

FIG. 6 is a schematic perspective view of automated fuel dispenser 600 for use in refueling of vehicles, such as autonomous vehicle 100. The automated fuel dispenser 600 is used to enable a flow of fuel from a fueling station reservoir to a fuel reservoir in a vehicle to refuel the vehicle. The automated fuel dispenser 600 includes a housing 602. In some embodiments, the automated fuel dispenser 600 includes components (not shown) located within the housing 602 that control and supply a fuel flow through the automated fuel dispenser 600. For example, automated fuel dispenser 600 may include, but not limited to, a motor, a pump, valves, fuel lines, sensors, and a processing device, such as processing devices described herein, disposed within the housing 602.

The automated fuel dispenser 600 may include at least one fuel hose 604 connected to the housing 602. In an embodiment, the automated fuel dispenser 600 may comprise any number of fuel hoses 604. For example, as shown in FIG. 6, the automated fuel dispenser 600 may include one fuel hose 604 coupled to a first side of the housing 602. However, the automated fuel dispenser 600 may include a second fuel hose 604 coupled to a second side of the housing 602. Each fuel hose 604 includes an elongate, flexible tubular body 606 having a first end 608 connected to the housing 602 and a second end 610 that includes a fuel nozzle 612. The fuel hose 604 is configured to enable a flow of fuel from fuel lines within the housing 602 to the fuel nozzle 612.

As shown in FIG. 6, the fuel nozzle 612 is coupled to the second end 610 of the tubular body 606. The fuel nozzle 612 includes a spout 614 configured to be inserted into a reservoir inlet of a vehicle, such as autonomous vehicle 100, to form a fluidic connection that can be used to supply fuel from the automated fuel dispenser 600 to a fuel reservoir of the vehicle during refueling of the vehicle. The fuel nozzle 612 also comprises a handle 615 to initiate and stop fuel flow through the automated fuel dispenser 600 based on a position of the handle 615 and a body 616 configured to enclose the discrete components of the fuel nozzle 612. For example, one exemplary component enclosed by the body may be a shut-off mechanism configured to stop the flow of fuel from the spout 614 into the vehicle fuel reservoir once a fuel level within the vehicle fuel reservoir reaches a predetermined level. More specifically, the shut-off mechanism may comprise a shut off valve (not shown) and an elongate tube (not shown) extending within the spout 614 to connect the shut off valve and a shut-off aperture positioned at the distal end of the spout 614. The shut-off valve may be configured to stop the flow of fuel based on pressure created in the vehicle fuel reservoir when fuel flows into the vehicle fuel reservoir to prevent over-filling of the vehicle fuel reservoir. In particular, when the fuel level within the vehicle fuel reservoir reaches the predetermined level, the fuel may reach the shut-off aperture and cause a change in pressure within the elongate tube that causes the shut-off valve to close. The closing of the shut-off valve causes the fuel pump to stop the flow of fuel and prevents over-filling of the vehicle fuel reservoir.

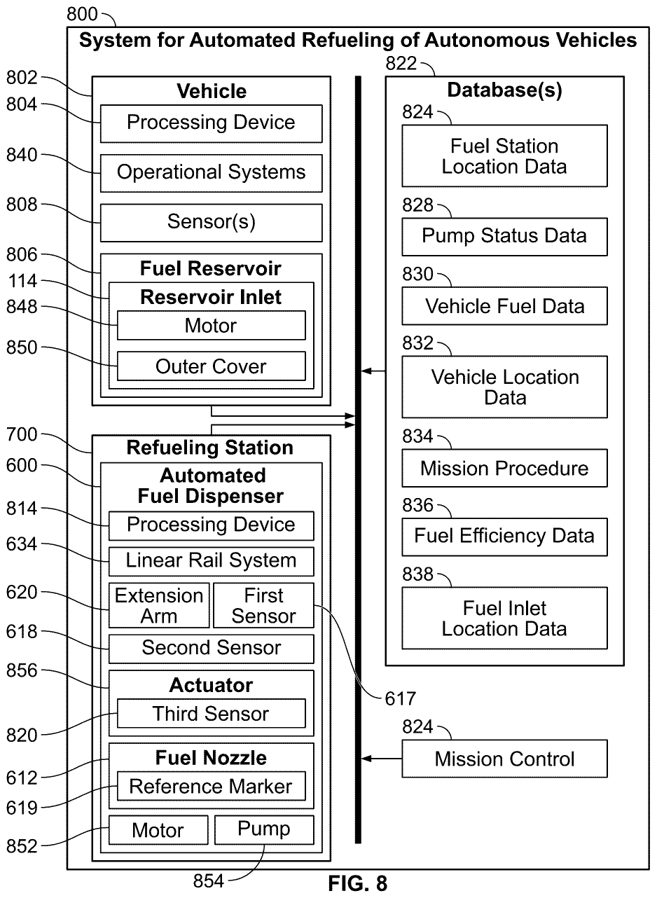

Additionally, the automated fuel dispenser 600 includes a first sensor 617. In an embodiment, the first sensor 617 may be a camera, but is not limited thereto. The at least one sensor 617 is configured to capture images of the environment surrounding automated fuel dispenser 600 in any aspect or field of view (FOV). The FOV can have any angle or aspect such that images of the areas ahead of, to the side, behind, above, or below automated fuel dispenser 600 may be captured. In some embodiments, the FOV may be limited to particular areas around automated fuel dispenser 600 (e.g., forward of automated fuel dispenser 600, to the sides of automated fuel dispenser 600, etc.) or may surround 360 degrees of automated fuel dispenser 600. In some embodiments, the image data generated by sensor 617 may be sent to a processing device, such as processing device 814 shown in FIG. 8, or other aspects of automated fuel dispenser 600 for one or more of identifying objects around the automated fuel dispenser 600 and controlling operation of the automated fuel dispenser 600 for movement of the fuel nozzle 612, described in more detail below.

The nozzle 612 includes a second sensor 618. As shown in FIG. 6, the second sensor 618 is disposed adjacent a fuel outlet of the spout 614. In an embodiment, the sensor 618 may be a pressure sensor, proximity sensor, or the like. The second sensor may be configured to enable a processing device, such as processing device 814, for the automated fuel dispenser 600 to determine when the spout 614 is inserted into the reservoir inlet to form the connection between the fuel nozzle 612 and the vehicle fuel reservoir.

In some embodiments, the fuel nozzle 612 may include at least one reference marker 619. As shown in FIG. 6, the at least one reference marker 619 is positioned on a portion of the body 617 of the fuel nozzle 612. The at least one reference marker 619 may allow autonomous vehicle sensors 202, shown in FIG. 4, to identify a specific reference point on the nozzle (e.g., body 617, spout 614, handle 615, or the like). The at least one reference marker 619 may be made of a metal material such as, copper, gold, or the like that provides high contrast from portions of the body 617 surrounding each reference marker 619.

As shown in FIG. 6, the automated fuel dispenser 600 includes an extension arm 620 with a first end 622 and a second end 624. The extension arm 620 is configured to extend and retract along a specified axis, such as axis 632. The extension arm 620 may be any arm capable of extending and retracting along the specified axis. In some embodiments, the extension arm 620 may include a plurality of tubular portions to allow the extension arm to extend and retract along the specified axis. As shown in FIG. 6, the extension arm 620 comprises a first tubular portion 626, a second tubular portion 628 nested within the first tubular portion 626 and configured to move relative to the first tubular portion 626, and a third tubular portion 630 nested within the second tubular portion 628 and configured to move relative to the second tubular portion 628. The plurality of tubular portions may include any number of tubular portions, such as three, four, or more tubular portions.

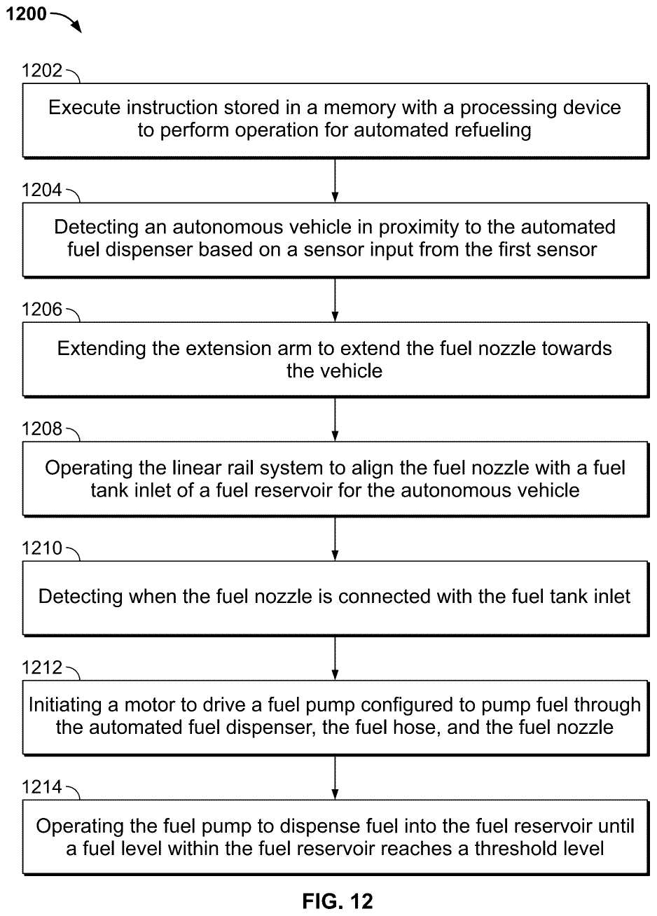

The fuel nozzle 612 may be mounted on the extension arm 620 at the first end 622 of the extension arm 620, as shown in FIG. 6. The extension arm 620 may be configured to enable movement of the fuel nozzle 612 along a specified axis, such as axis 632, based on a movement of each of the second tubular portion 628 and the third tubular portion 630. For example, the extension arm 620 may be configured to enable movement of the nozzle 612 along axis 632 to extend the nozzle 612 in a direction away from the housing 602 and to retract the nozzle 612 in a direction towards the housing 602 based on a movement of the second tubular portion 628 relative to the first tubular portion 626 and a movement of the third tubular portion 630 relative to the second tubular portion 628. The extension arm 620 may be configured to enable movement of fuel nozzle 612 for use during automated refueling of vehicles, as described below in FIGS. 8 and 12. In some embodiments, a processing device, such as processing device 812 described in FIG. 8, may be used to control operation of the extension arm 620 for movement of the fuel nozzle 612, based on the data generated by sensor 617 during automated refueling of vehicles, as described below in FIGS. 8 and 12.

The automated fuel dispenser 600 may include an actuator configured to enable operation of the handle 615 of the fuel nozzle 612 for refueling. The actuator may be configured to apply a driving pressure to cause the handle 615 to move from an idle position to initiate a motor and a fuel pump of the automated fuel dispenser 600 to enable flow of fuel through the automated fuel dispenser 600 to the spout 614. The actuator may be configured to release pressure from the handle 615 to allow the handle 615 to return to the idle position to stop the motor, the fuel pump, and the flow of fuel through the automated fuel dispenser 600 to the spout 614.

The extension arm 620 may be mounted on a linear rail system 634 at the second end 624 of the extension arm 620, as shown in FIG. 6. In some embodiments, the linear rail system 634 may include a plurality of rails. As shown in FIG. 6, the linear rail system 634 comprises a first rail 636a and a second rail 636b. However, the plurality of rails may include any number of rails, such as three, four, or more rails. The first tubular member 624 is mounted on a platform 636a that is configured to move along a bar 640a of the first rail 636a, as shown in FIG. 6. The bar 640a may be driven by a motor 642a to cause the bar 640a to rotate in a first direction or a second direction and enable movement of the platform 636a along the first rail 636a and along a first specified axis, such as axis 644, based on the rotation of the bar 640a in the first direction or in the second direction. For example, when the bar 640a is rotated in a first direction, the platform 636a may be configured to move in a first direction (e.g., upward) along the bar 640a and when the bar 640a is rotated in the second direction, the platform 636a may be configured to move in a second direction (e.g., downward), that is opposite the first direction, along the bar 640a. Additionally, the movement of the platform 636a may also enable movement of the extension arm 620 and/or the fuel nozzle 612 along the first rail 636a and in the direction defined by the first specified axis to position the fuel nozzle 612 in the direction defined by the first specified axis during automated refueling of vehicles, as described below in FIGS. 8 and 12. A processing device, such as processing device 812 described in FIG. 8, may be used to control operation of the motor 642a and in turn, control the movement of the fuel nozzle 612. The movement of the fuel nozzle is based on the data generated by sensor 617 during automated refueling of vehicles, as described below in FIGS. 8 and 12.

As shown in FIG. 6, the first rail 636a is mounted on a platform 636b that is configured to move along a bar 640b of the second rail 636b. The bar 640b may be driven by a motor 642b to cause the bar 640b to rotate in a first direction or a second direction and enable movement of the platform 636b along the second rail 636b and in the direction defined by a second specified axis, such as axis 646 based on the rotation of the bar 640b in the first direction or the second direction. For example, when the bar 640b is rotated in a first direction, the platform 636b may be configured to move in a first direction (e.g., leftward) along the bar 640b and when the bar 640b is rotated in the second direction, the platform 636b may be configured to move in a second direction (e.g., rightward), that is opposite of the first direction, along the bar 640b. Additionally, the movement of the platform 636b may also enable movement of the first rail 636a and the fuel nozzle 612 along the second rail 636b and in the direction defined by the second specified axis to position the fuel nozzle 612 in the direction defined by the second specified axis during automated refueling of vehicles, as described below in FIGS. 8 and 12. A processing device, such as processing device 812 described in FIG. 8, may be used to control operation of the motor 642b for movement of the fuel nozzle 612 based on the data generated by sensor 617 during automated refueling of vehicles, as described below in FIGS. 8 and 12.

In an alternative embodiment, the extension arm 620 may be mounted on the platform 636a and the second rail 636b may be mounted on the platform 636a. In the alternative embodiment, the movement of the platform 636b, as described above, along the second rail 636b may enable movement of the fuel nozzle 612 along axis 646 to position the fuel nozzle 612 along axis 646 during automated refueling of vehicles, as described below in FIGS. 8 and 12. Additionally, in the alternative embodiment, the movement of the platform 636a, as described above, may enable movement of the second rail 636b and the fuel nozzle 612 in the direction defined by axis 644 to position the fuel nozzle 612 in the direction defined by axis 644 during automated refueling of vehicles, as described below in FIGS. 8 and 12.

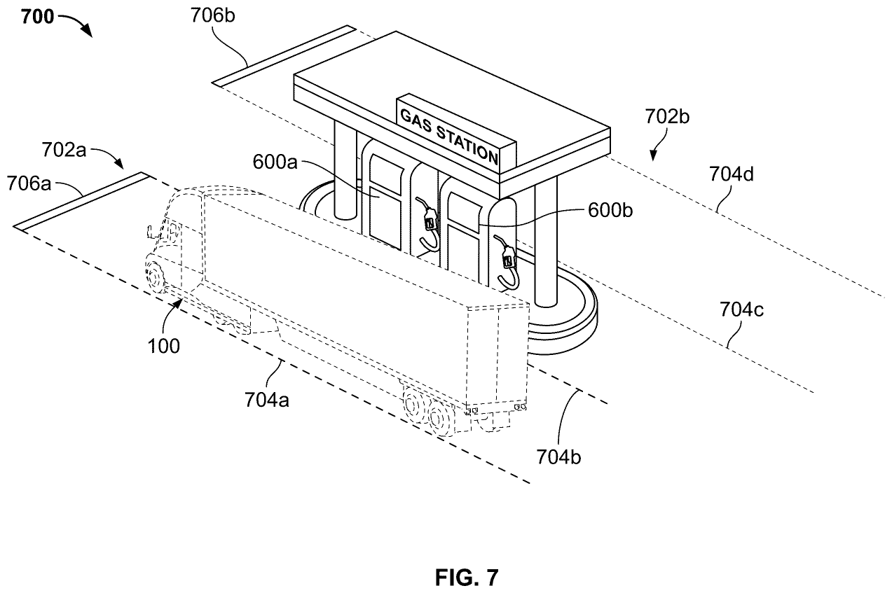

FIG. 7 is a perspective view of an exemplary refueling station 700 including two automated fuel dispensers 600a, 600b previously described and shown in FIG. 6. The first automated fuel dispenser 600a and the second automated fuel dispenser 600b are positioned between a first alignment lane 702a and a second alignment lane 702b for the refueling station. Alternatively, rather than locating automated fuel dispensers 600a, 600b between alignment lanes 702a, 702b, the refueling station 700 may include alignment lanes 702a, 702b located between automated fuel dispensers 600a, 600b. Each of the first automated fuel dispenser 600a and the second automated fuel dispenser 600b may be configured to provide fuel to a vehicle, such as autonomous vehicle 100, positioned along or aligned with a corresponding alignment lane of the first alignment lane 702a and the second alignment lane 702b. For example, in an embodiment, the first automated fuel dispenser 600a may be configured to provide fuel to vehicles positioned along/aligned with the first alignment lane 702a and the second automated fuel dispenser 600b may be configured to provide fuel to vehicles positioned along/aligned with the second alignment lane 702b, but are not limited thereto.

The first alignment lane 702a and the second alignment lane 702b may be used by an autonomous vehicle, such as autonomous vehicle 100, to properly align the reservoir inlet 114 of the autonomous vehicle with the corresponding automated fuel dispenser 600a, 600b for refueling. As shown in FIG. 7, the first alignment lane 702a is defined by a first lane line 704a, a second lane line 704b, and a stop line 706a. The first lane line 704a may be configured to enable the autonomous vehicle to position a first side (e.g., a left side) of the autonomous vehicle within the first alignment lane 702a for alignment of the reservoir inlet with an automated fuel dispenser (e.g., the first automated fuel dispenser 600a, the second automated fuel dispenser 600b, or the like). The second lane line 704b may be configured to enable the autonomous vehicle to position a second side (e.g., a right side) of the autonomous vehicle within the first alignment lane 702a for alignment of the reservoir inlet with the automated fuel dispenser. The stop line 706a may be configured to enable the autonomous vehicle to position a first end (e.g., a front end) of the autonomous vehicle within the first alignment lane 702a for alignment of the reservoir inlet with the automated fuel dispenser. In an exemplary embodiment, the first alignment lane 702a is used by an autonomous vehicle with the reservoir inlet positioned on the right side of the autonomous vehicle 100.

The second alignment lane 702b is defined by a first lane line 704c, a second lane line 704d, and a stop line 706b. The first lane line 704c may be configured to enable the autonomous vehicle to position a first side (e.g., a left side) of the autonomous vehicle within the second alignment lane 702b for alignment of the reservoir inlet with an automated fuel dispenser (e.g., the first automated fuel dispenser 600a, the second automated fuel dispenser 600b, or the like). The second lane line 704d may be configured to enable the autonomous vehicle to position a second side (e.g., a right side) of the autonomous vehicle within the second alignment lane 702b for alignment of the reservoir inlet with the automated fuel dispenser. The stop line 706b may be configured to enable the autonomous vehicle to position a first end (e.g., a front end) of the autonomous vehicle within the second alignment lane 702b for alignment of the reservoir inlet with the automated fuel dispenser. In an exemplary embodiment, the second alignment lane 702b is used by an autonomous vehicle with the reservoir inlet positioned on the left side of the autonomous vehicle.

FIG. 8 is a block diagram of an exemplary system 800 for automated refueling of autonomous vehicles. The system 800 generally includes one or more vehicles 802 (e.g., autonomous vehicle 100, semi-autonomous vehicle, non-autonomous vehicle, or the like). Each vehicle 802 includes a processing device 804 (e.g., computing system 200, computing system 300, or the like) configured to receive and process data relating to fuel level with a fuel reservoir 806 for the vehicle 802 and/or a surrounding environment of the vehicle 802. In some embodiments, at least some of the data received by the processing device 804 may be data from one or more sensors 808 (e.g., sensors 202 and fuel sensor 208). For example, the processing device 804 may continuously monitor a fuel level within the fuel reservoir 806 associated with the vehicle 802 using inputs from one or more of the sensors 808 as the vehicle travels along routes to complete a mission, and/or one or more of sensors 808 can detect objects for refueling in the vicinity of the vehicle 802 (e.g., automated fuel dispenser 600, refueling station 700, or the like) while making a refueling stop.

Additionally, the system 800 generally includes one or more automated fuel dispensers 600. Each automated fuel dispenser 600 may be located at a refueling station 700 of one or more refueling stations within the system 800. Each automated fuel dispenser 600 includes a processing device 814 (e.g., computing system 300, or the like) configured to receive and process data relating to a surrounding environment of the automated fuel dispenser 600 and regulate operation of the automated fuel dispensers 600. Each refueling station also includes an extension arm 620 and a linear rail system 634 in communication with the processing device 814 to enable automated movement of a fuel nozzle during automated refueling of vehicles, as described herein. In some embodiments, at least some of the data received by the processing device 814 can be data from first sensor 617 and/or second sensor 618. For example, the processing device 814 can detect when an autonomous vehicle is in close proximity to the automated fuel dispenser 600 using inputs from the first sensor 617 and/or when a fuel nozzle (e.g., fuel nozzle 612) of the automated fuel dispenser 600 is inserted into a reservoir inlet 114 of an autonomous vehicle 802 using inputs from the second sensor 618.

The vehicle 802 can include one or more databases 822 (e.g., memory 306) configured to receive and electronically store data. For example, database 822 may include fuel station location data 824 including the location for each of the one or more automated fuel dispensers 600 and corresponding fuel stations 700. In some embodiments, the database 822 can be stored externally from the vehicle 802 and the vehicle 802 can be in communication with the external database 822 for receiving and/or transmitting data associated with the system 800. Each vehicle 802, each automated fuel dispenser 600, the database 822, and mission control 826 may each be in communication for operation of the system 800. For example, processing devices 814 for automated fuel dispensers 600 may be configured to communicate pump status data 828 that indicates whether the automated fuel dispensers 600 are available for use by a vehicle 802 for refueling and processing devices 804 for vehicles 802 may be configured to communicate vehicle fuel data 830 indicating a remaining amount of fuel within a fuel reservoir 806 for each vehicle 802 and vehicle location data 832 indicating a current location of each vehicle 802.

During operation of each of the vehicles 802 along respective missions 834 to an intended destination, each processing device 804 receives a signal from the one or more sensors 808, such as the fuel sensor 208, of the vehicle 802 as an input. In an embodiment, the signal may indicate a fuel level within the fuel reservoirs 806 of the vehicles 802. Each processing device 804 may be configured to determine the vehicle fuel data 822 for a corresponding vehicle 802 based on the signal from the one or more sensors 808. Additionally, each processing device 804 is configured to determine when the remaining fuel level is less than a threshold fuel level for a corresponding vehicle 802. The threshold fuel level may be a volume of remaining fuel within the fuel reservoir 806 to allow the vehicle 802 to maintain operation along the mission 834 without increased risk of running out of fuel. For example, in an embodiment, the threshold fuel level may be 2 gallons, 5 gallons, 10 gallons, or the like.

When the remaining fuel volume and associated level for a vehicle 802 is less than the threshold fuel level, the processing device 804 for the vehicle 802 identifies at least one candidate refueling station from the one or more refueling stations. The processing device 804 may use vehicle location data 832 for the vehicle 802, the fuel station location data 824, and/or the mission procedure 834 for the vehicle 802 to identify the at least one candidate refueling station 700. In an embodiment, the at least one candidate refueling station 700 may be the refueling stations 700 that are in closest proximity to the current location of the vehicle 802. For example, in such an embodiment, the at least one candidate refueling stations may be the ten refueling stations that are in closest proximity to the current location of the vehicle 802. However, the at least one candidate refueling station is not limited to ten and can be any number of refueling stations that are in closest proximity to the current location of the vehicle 802, such as 3, 5, 8, or the like.

In some embodiments, the processing device 804 for the vehicle 802 may determine an expected travel mileage for the vehicle 802. The expected travel mileage is a predicted distance the at least one vehicle 802 will be able to travel before running out of fuel. In an embodiment, the expected travel mileage may be calculated using the vehicle fuel data 830 and fuel efficiency data 836 for the vehicle 802. For example, the expected travel mileage may be a product of multiplying the vehicle fuel data 830 and fuel efficiency data 836 for the vehicle 802. The fuel efficiency data 836 is a measure of the distance the at least one vehicle 802 is expected to be able to travel for a given amount of fuel. For example, the fuel efficiency data 836 may be a measure of the distance the at least one vehicle 802 can travel using a single gallon of fuel. The fuel efficiency data 836 may be a fuel efficiency for a lifetime of the vehicle 802, a fuel efficiency for the vehicle during the current mission procedure, or the like.

The processing device 804 may use the expected travel mileage to filter the at least one candidate refueling station to ensure the vehicle 802 is able to reach each of the at least one candidate refueling station. In particular, the processing device 804 may determine a travel distance for the vehicle 802 to reach each of the at least one candidate refueling stations, compare the travel distance for each of the at least one candidate refueling stations and the expected travel mileage, and filter the at least one candidate refueling station based on the comparison of the travel distance for each of the at least one candidate refueling stations and the expected travel mileage. For example, when the travel distance for one candidate refueling station is greater than the expected travel mileage, the processing device 804 can remove that refueling station from consideration as a candidate refueling station for the vehicle 802.

Additionally, processing device 804 may use the pump status data 828 to filter the at least one candidate refueling station to ensure the vehicle 802 is able to use each of the at least one candidate refueling station with minimal delay. In particular, processing device 804 may receive the pump status data 828 for each of the at least one candidate refueling stations from the database 822 and filter the at least one candidate refueling station based on the pump status data 828. For example, when the pump status data 828 indicates a candidate refueling station is occupied by another vehicle 802, the processing device 804 may remove that refueling station from consideration as a candidate refueling station for the vehicle 802.

The processing device 804 for the vehicle 802 is configured to select a preferred refueling station from the at least one candidate refueling station. The processing device 804 may use at least one of vehicle location data 832 for the vehicle 802, the fuel station location data 824, and/or a mission procedure 834 to select the preferred refueling station for the vehicle 802. In one exemplary embodiment, the preferred refueling station may be the refueling station in closest proximity to the vehicle 802. In another exemplary embodiment, the preferred refueling station may be a refueling station that minimizes disruption to the mission procedure 834 for the vehicle 802. For example, the processing device 804 may be configured to determine an added travel time for the vehicle 802 to reach each candidate refueling station based on at least one of vehicle location data 824 for the vehicle 802, the fuel station location data 818, and/or a mission procedure 834 for the vehicle 802 and select the preferred refueling station based on a comparison of each added travel time for the vehicle 802 to reach each candidate refueling station. In particular, the processing device 804 may be configured to select the refueling station with the least added travel time.

The preferred refueling station can be transmitted to one or more operational systems 840 (e.g., autonomy computing system 200 or the like) of the vehicle 802 to regulate operation of the vehicle 802 to the preferred refueling station. In some embodiments, the mission procedure 834 for the vehicle 802 may be updated to include the preferred refueling station.

Each refueling station 700, including the preferred refueling station, may include a first alignment lane (e.g., alignment lane 702a or the like) positioned on a first side of the refueling station and/or a second alignment lane (e.g., alignment lane 702b or the like) positioned on a second side of the refueling station. One of the first alignment lane 702a and the second alignment lane 702b may be used by the vehicle 802 to properly align the reservoir inlet for the autonomous vehicle 802 with the corresponding automated fuel dispenser 600 for refueling. Once the vehicle 802 reaches the preferred fuel station, the processing device 804 may identify a selected alignment lane from the first alignment lane and the second alignment lane of the preferred refueling station when each of the first alignment lane and the second alignment lane are present. In particular, database 822 may store reservoir inlet location data 838 for the vehicle 802 indicating whether the reservoir inlet for each vehicle 802 is located on a first side (e.g., a left side) or a second side (e.g., a right side) of the vehicle 802. The processing device 804 may use the reservoir inlet location data 838 to identify the selected alignment lane from the first alignment lane and the second alignment lane to allow the vehicle 802 to align itself with an automated fuel dispenser 600, as described below.

In some embodiments, the processing device 804 may use the selected alignment lane to align the vehicle 802 with the at least one automated fuel dispenser 600 of the preferred refueling station 700. In particular, the processing device 804 may identify action sequences for aligning the vehicle 802 with the selected alignment lane based on images captured by cameras on the sides of a vehicle. For example, the processing device 804 can receive images from cameras 110 located on the sides of the vehicle 100 when operating along a road. The processing device 804 can execute one or more models to extract features (e.g., label pixels) from the images. From the extracted features, the processing device 804 can identify features that correspond to alignment lane lines (e.g., the processing device 804 can identify lane lines for the selected alignment lane from pixels of the images labeled with a lane line label). The processing device 804 can generate a two-dimensional model (e.g., a two-dimensional plane) at the location at which the tires of the vehicle touch the road. The processing device 804 can insert representations (e.g., point clouds or lines of best fit) of the detected alignment lane lines onto the two-dimensional model based on the features that the processing device 804 extracted from the images. The processing device 804 may then activate an alignment sequence to move the vehicle to a defined location within the alignment lane lines.

In particular, aligning the vehicle using the selected alignment lane may comprise receiving, by the processing device 804, at least one of a first image of a first lane line (e.g., first lane line 704a or the like) of the selected alignment lane from a first sensor from the one or more sensors 808 positioned on a first side of the vehicle 802, a second image of a second lane line (e.g., second lane line 704b or the like) of the selected alignment lane from a second sensor from the one or more sensors 808 positioned on a second side of the vehicle 802, and a third image of a stop line (e.g., stop line 706a or the like) of the selected alignment lane from a third sensor from the one or more sensors 808 positioned on the first end of the vehicle 802. The first image can include images of the first lane line of the selected alignment lane and portions of the first side of the vehicle 802, such as wheels 106a on the first side, a fender on the first side of the vehicle 802, or the like. The second image can include images of the second lane line of the selected alignment lane and portions of the second side of the vehicle 802, such as wheels 106a on the second side, a fender on the second side of the vehicle, or the like. The third image can include images of the stop line of the selected alignment lane and portions of the first end of the vehicle 802 such as a hood, bumper, or the like.

The first sensor, the second sensor, and the third sensor can each capture images at a defined orientation (e.g., a defined angle) relative to the ground or a plane parallel to the orientation of the vehicle or the ground. Each of the first sensor, the second sensor, and the third sensor can have a field of view in front of the vehicle (e.g., in the direction the vehicle travels in a drive mode instead of a reverse mode). The fields of view of the sensors may include the ground next to the vehicle, the tires on the respective sides/end of the vehicle, and the area in front of the vehicle. Because of the locations of the first sensor, the second sensor, and the third sensor on the vehicle, the first, second, and third images that the three sensors capture can include the alignment lane lines directly next to the vehicle when vehicle has entered the alignment lane as well as lane lines in front of the vehicle before the vehicle has entered the alignment lane.

Once the processing device 804 receives at least one of the first image, the second image, and the third image, the processing device 804 may detect at least one of the first lane line from the first image, the second lane line from the second image, and the stop line from the third image. The processing device 804 may detect the first lane, the second lane, and/or the third lane using image processing techniques, such as object detection techniques. For example, the processing device 804 can input the first image into a machine learning model (e.g., a neural network, such as a convolutional neural network). The processing device 804 can execute the machine learning model. The machine learning model can output features or labels for individual pixels of the first image and/or objects the machine learning model identified from the first image. The different labels or features may include identifications of different types of objects, such as a curb of the refueling station, an automated fuel dispenser, or the like. The machine learning model can output labels for the pixels of the first lane line that is depicted in the first image or a label that identifies the first alignment lane line as an object identified from the first image. The processing device 804 can similarly execute the machine learning model to obtain labels or features identifying the second alignment lane line depicted in the second image and/or the stop line depicted in the third image. The processing device 804 can detect the first alignment lane line, the second alignment lane line, and the stop line from the respective first, second, and third images by identifying the output labels or features from the machine learning model. The processing device 804 can use any technique to identify the first and second alignment lane lines and/or the stop line from images.

The processing device 804 can determine a first location of the first alignment lane line relative to a first defined location of the vehicle, a second location of the second alignment lane line relative to a second defined location of the vehicle, and a third location of the stop line relative to a third defined location of the vehicle. The first defined location of the vehicle can be a first side of the vehicle (e.g., the left side of the vehicle). The second defined location of the vehicle can be a second side of the vehicle (e.g., the right side of the vehicle). The third defined location of the vehicle can be a first end of the vehicle (e.g., the front end of the vehicle). The processing device 804 can determine the first location of the first alignment lane line based on the location of the first alignment lane line in the first image (e.g., the pixels for which the machine learning model output labels identifying the first alignment lane line). For instance, each pixel may correspond to a particular distance between the first defined location of the vehicle and a position of an alignment lane line or other object on the road. The processing device 804 can identify the pixels that are labeled as corresponding to the first alignment lane line and identify the location of the first alignment lane line relative to the first defined location based on the stored corresponding distance for the pixel. The processing device 804 can similarly determine a distance for each pixel the machine learning model labeled as corresponding to the first alignment lane line, thus the processing device 804 can create a point cloud of locations relative to the first defined location of the vehicle (e.g., distances from the first defined location of the vehicle) in which the first alignment lane line is depicted in the first image. The processing device 804 can similarly determine the location of the second alignment lane line relative to the second defined location of the vehicle from the second image and/or the location of the stop line relative to the third defined location of the vehicle from the third image.

The processing device 804 can execute an alignment sequence based on the first location of the first alignment lane line, the second location of the second alignment lane line, and/or the third location of the stop line. The alignment sequence can be a control maneuver in which the processing device 804 moves (e.g., automatically moves) the vehicle into position between each of the first alignment lane line, the second alignment lane line, and the stop line.

The processing device 804 can execute the alignment sequence in response to detecting and selecting an alignment lane (e.g., the selected alignment lane) at a refueling station. For example, the processing device 804 can identify or determine the distances between the different points of the first lane line, the second lane line, and the stop line (e.g., the distances of the points of the first alignment lane line, the second alignment lane line, and the stop lines) and the first defined location, the second defined location, and the third defined location, respectively. The processing device 804 can compare the distances to a threshold distance (e.g., a defined threshold). Responsive to determining at least one of the distances is greater than the threshold distance, the processing device 804 can execute the alignment sequence until the each of the distances is less than the threshold distance. Once each of the distances is less than the threshold distance, the processing device 804 may shut off an engine of the vehicle 802 to allow the vehicle to be refueled.

Once the vehicle is aligned and the engine is shut off, at least one of the sensors 808 of vehicle 802 may be configured to capture at least one image of a fuel nozzle 612 of an automated fuel dispenser 600 that is located adjacent to the vehicle 802. The at least one image may be captured while the fuel nozzle 612 is automatically extended towards the vehicle 802 and/or retracted away from the vehicle 802 by an extension arm 620 of the fuel dispenser 600. The at least one of the sensors 808 may be positioned on a side of the vehicle positioned proximal to the automated fuel dispenser 600 (e.g., a side of the vehicle including the reservoir inlet 114). The processing device 804 may receive the at least one image of the automated fuel dispenser 600. The at least one image can include images of a fuel nozzle 612 of the automated fuel dispenser 600, at least one reference marker 619 positioned on the fuel nozzle 612, the housing of the automated fuel dispenser 600 (e.g., housing 602, or the like), or the like.

The processing device 804 may identify at least one of the fuel nozzle 612 and the at least one reference marker 619 from the at least one image of the automated fuel dispenser 600. The processing device 804 may identify the fuel nozzle 612 and the at least one reference marker 619 using image processing techniques, such as object detection techniques, as described above.

The processing device 804 can determine a location of the fuel nozzle 612 relative to a defined location of the vehicle while the fuel nozzle 612 is automatically extended towards the vehicle 802 by the automated fuel dispenser 600 for refueling of the vehicle 802 and/or while the fuel nozzle 612 is automatically retracted away the vehicle 802 by the automated fuel dispenser 600 after refueling of the vehicle 802. The defined location of the vehicle can be a reservoir inlet 114 of the vehicle 802. The processing device 804 can determine the location of the fuel nozzle 612 based on the location of the fuel nozzle 612 and/or the at least one reference marker 619 in the at least one image (e.g., the pixels for which the machine learning model output labels identifying the fuel nozzle). For instance, each pixel may correspond to a particular distance between the reservoir inlet 114 of the vehicle 802 and a position of the fuel nozzle 612. The processing device 804 can identify the pixels that are labeled as corresponding to the fuel nozzle 612 and/or reference marker 619 and identify the location of the fuel nozzle 612 relative to the reservoir inlet 114 based on the stored corresponding distance for the pixel. The processing device 804 can similarly determine a distance for each pixel the machine learning model labeled as corresponding to the fuel nozzle 612, thus the processing device 804 can create a point cloud of locations relative to the reservoir inlet 114 (e.g., distances from the reservoir inlet of the vehicle) in which the fuel nozzle 612 is depicted in the at least one image. The processing device 804 can similarly determine the location of reference markers 844 relative to the reservoir inlet 114 of the vehicle 802 from the at least one image to determine a location of the fuel nozzle 612 relative to reservoir inlet 114 of the vehicle 802.

The processing device 804 can compare the distances to a fuel nozzle threshold distance (e.g., a defined threshold) while the fuel nozzle 612 is being automatically extended towards the vehicle 802 and/or reservoir inlet 114. Once each of the distances is less than the threshold distance, the processing device 804 may transmit a signal to a prime mover, such as a motor 848 to automatically open an outer cover 850 of the reservoir inlet 114. Once the outer cover 850 is open, the fuel nozzle 846 may be inserted into the reservoir inlet 114 to create a fluidic connection between the fuel reservoir 806 and the fuel nozzle 612 to allow the automated fuel dispenser 600 to dispense fuel into the fuel reservoir 806 through the hose and fuel nozzle for refueling of the vehicle 802.

The processing device 804 can similarly compare the distances to the fuel nozzle threshold distance while the fuel nozzle 844 is being automatically retracted away from the vehicle 802 and/or reservoir inlet 114 after refueling of the vehicle 802. Once each of the distances is greater than the threshold distance, the processing device 804 may transmit a signal to the motor 848 to automatically close the outer cover 850 of the reservoir inlet 114. The processing device 804 may additionally one or more operational systems 840 to regulate operation of the vehicle 802 to exit the refueling station 810 and resume operation along the mission procedure 834 after refueling.

Additionally, once the vehicle is aligned and the engine is shut off, a first sensor 617 of an automated fuel dispenser 600 may be configured to capture an image of a side of the vehicle 802 proximal to the automated fuel dispenser 600. The first sensor 617 may be positioned on the fuel nozzle 612, as described in FIG. 6. The processing device 814 may receive the image of the side of the vehicle proximal to the automated fuel dispenser 600. The at least one image can include images of the reservoir inlet 114, at least one inlet reference marker positioned on an inner cover of the reservoir inlet, wheels of the side of the vehicle proximal to the automated fuel dispenser 600, or the like.

The processing device 814 may receive the image as an input and detect at least one of the vehicle 802 and/or the at least one reference marker from the image of the automated side of the vehicle 802 proximal to the automated fuel dispenser 600. The processing device 804 may detect the vehicle 802 and the at least one inlet reference marker using image processing techniques, such as object detection techniques, as described above.

When the vehicle 802 and/or the at least one inlet reference marker are detected, the processing device 814 transmits a signal to the extension arm 620 of the automated fuel dispenser 600 to cause the extension arm 620 to extend and, thereby, advance the fuel nozzle towards the vehicle 802. While the fuel nozzle is moved towards the vehicle by the extension arm 620, the first sensor of the one or more sensors 808 may capture at least one additional image of the fuel nozzle while the fuel nozzle is automatically extended towards the vehicle 802.

The processing device 814 can determine a location of the reservoir inlet 114 of the vehicle 802 relative to a defined location of the fuel nozzle while the fuel nozzle is automatically extended towards the vehicle 802 for refueling of the vehicle 802 and/or while the fuel nozzle is automatically retracted away the vehicle 802 after refueling of the vehicle 802. The defined location of the fuel nozzle can be a fuel outlet of a spout (e.g., the fuel outlet of spout 614). The processing device 814 can determine the location of the reservoir inlet based on the location of the reservoir inlet 114 and/or the at least one inlet reference marker in the at least one additional image (e.g., the pixels for which the machine learning model output labels identifying the reservoir inlet and/or inlet reference marker). For instance, each pixel may correspond to a particular distance between the fuel nozzle 844 and a position of the reservoir inlet 114 of the vehicle 802. The processing device 814 can identify the pixels that are labeled as corresponding to the reservoir inlet 114 and/or inlet reference marker and identify the location of the reservoir inlet 114 relative to the fuel outlet of the spout based on the stored corresponding distance for the pixel. The processing device 814 can similarly determine a distance for each pixel developed by the machine learning model and labeled as corresponding to reservoir inlet 114, as described above, thus the processing device 804 can create a point cloud of locations relative to the fuel nozzle 612 (e.g., distances from the fuel nozzle) in which the reservoir inlet is depicted in the at least one additional image. The processing device 814 can similarly determine the location of the inlet reference marker relative to the fuel nozzle 612 from the at least one image to determine a location of the reservoir inlet 114 of the vehicle 802 relative to the fuel nozzle 612 of the automated fuel dispenser 600 once the outer cover 850 is actuated into an open position, as described above.

The processing device 814 transmits a signal to the motors of the linear rail system 634 to operate the linear rail system 634 to align the fuel nozzle 612 with the reservoir inlet 114 of the fuel reservoir 806 of the autonomous vehicle 802. In particular, the processing device 814 may transmit a signal to first motor (e.g., motor 642a, motor 642b, or the like) of the linear rail system 634 to actuate a first linear rail (e.g., rail 636a, rail 636b, or the like) of the linear rail system 634 to adjust the position of the fuel nozzle 612 along the first axis. The processing device 814 may cause the first motor to actuate the first linear rail in a first direction or a second direction based on the location of the reservoir inlet 114 along the first axis to ensure position of the fuel nozzle matches a position of the reservoir inlet 114 along the first axis. Additionally, the processing device 814 may transmit a signal to second motor (e.g., motor 642a, motor 642b, or the like) of the linear rail system 634 to actuate a second linear rail (e.g., rail 636a, rail 636b, or the like) of the linear rail system 634 to adjust the position of the fuel nozzle 612 along the second axis. The processing device 814 may cause the second motor to actuate the second linear rail in a first direction or a second direction based on the location of the reservoir inlet 114 along the second axis to ensure the position of the fuel nozzle aligns with a position of the reservoir inlet 114 along the second axis.

The processing device 814 detects when a spout of the fuel nozzle 612 is connected with the reservoir inlet 114 to ensure a proper connection between the spout and the reservoir inlet 114. In some embodiments, the processing device 814 may receive a signal from a second sensor 618. The second sensor 618 may be disposed adjacent to a fuel outlet of the fuel nozzle 612 to detect when the spout is inserted into the reservoir inlet 114.

Once the connection between the spout and the reservoir inlet 114 is detected, the processing device 814 initiates a motor 852 to drive a fuel pump 854 for the automated fuel dispenser 600. The fuel pump 854 is configured to enable movement of fuel through the automated fuel dispenser and the fuel hose to allow fuel to be dispensed through the spout of the fuel nozzle 612 into the fuel reservoir 806 for refueling of the vehicle 802. In some embodiments, initiating the motor 852 and the fuel pump 854 may comprise the processing device 814 transmitting a signal to at least one of the motor 852, the fuel pump 854, and an actuator 856 positioned on the extension arm 620 to apply pressure to the handle of the fuel nozzle to actuate the handle from the first position to the second position to initiate the motor 852 and the fuel pump 854 to enable movement of the fuel through the automated fuel dispenser 600 for refueling of the vehicle 802.

The processing device 814 may operate the motor 852 and the fuel pump 854 to continually move fuel through the automated fuel dispenser 600, the fuel hose, and the fuel nozzle into the fuel reservoir 806 of the autonomous vehicle 802 to refuel the autonomous vehicle 802. The processing device 814 may operate the motor 852 and the fuel pump 854 until the level of fuel contained within the fuel reservoir 806 reaches a threshold level. In an embodiment, the processing device 814 may receive a signal from at least one of a third sensor 820 positioned on the actuator 842, the processing device 804 of the vehicle 802, the fuel pump 854, and/or the motor 852. The third sensor 820 may be a tactile sensor configured to detect tactile feedback while the handle is in the second position, but is not limited thereto. For example, the third sensor 820 may be configured to detect tactile feedback caused by the shutting of the shut-off valve within the fuel nozzle 612 when the fuel level in the reservoir 806 reaches the threshold level and transmit a signal to the processing device 814 to cause the processing device 814 to shut-off the motor 852 and the fuel pump 854. In another embodiment, processing device 804 of the vehicle 802 may receive an input signal from fuel sensors of the one or more sensors 808 positioned within the fuel reservoir 806 indicating the fuel level and processing device 804 may transmit a signal to the processing device 814 of the automated fuel dispenser 600 when the fuel level reaches the threshold level to cause the processing device 814 to shut-off the motor 852 and/or the fuel pump 854. In another embodiment, processing device 814 may receive an input signal from the motor 852 and/or the fuel pump 854 when the shut-off valve stops a flow a fuel when the fuel level within the fuel reservoir 806 reaches the threshold level.

When refueling is complete, the processing device 814 transmits a signal to an extension arm 620 to cause the extension arm 620 to start to retract and, thereby, retract the fuel nozzle 844 from the reservoir inlet 114 and the vehicle 802 and return the fuel nozzle 844 to an idle position adjacent to the automated fuel dispenser 600. Additionally, the processing device 814 may transmit a signal to the motors of the linear rail system 634 to return the fuel nozzle to the idle position. When refueling is complete, the vehicle 802 may be restarted by processing device 804 enabling the vehicle to exit the refueling station 810 and resume operation along the mission procedure 834.

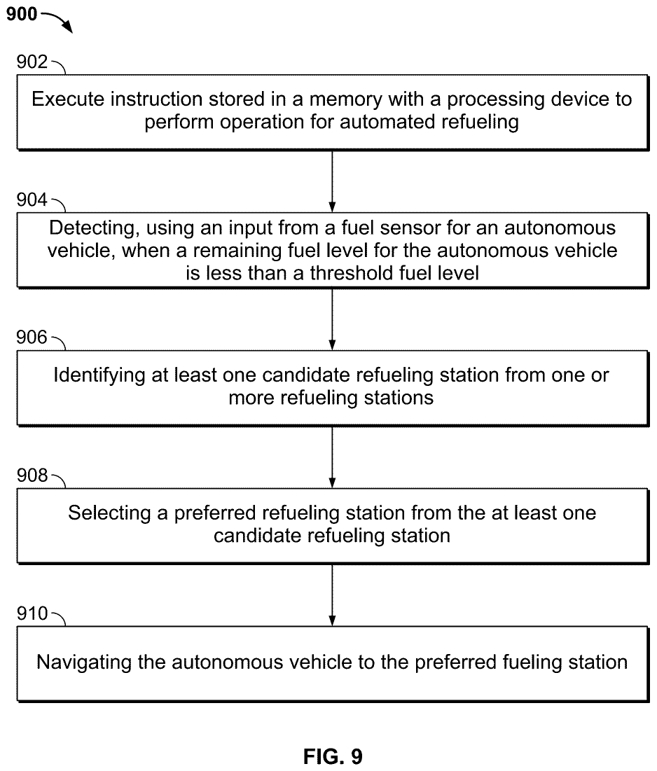

FIG. 9 is a flowchart of an exemplary method 900 for automated refueling for autonomous vehicles by the exemplary system 800 discussed herein. At 902, a processing device (e.g., computing system 200, computing system 300, or the like) can execute instructions stored in a memory to perform operations for automated refueling. At 904, the operations can include detecting, using an input from the fuel sensor (not shown), when a remaining fuel level for a corresponding autonomous vehicle 100 is less than a threshold fuel level. At 906, the operations can include identifying at least one candidate refueling station from one or more refueling stations 700 of the system for automatic refueling of autonomous vehicles. At 908, the operations can include selecting a preferred refueling station from the at least one candidate refueling station. In some embodiments, the operations can include updating a mission procedure for the autonomous vehicle with the preferred refueling station. At 910, the operations can include navigating the autonomous vehicle 100 to the preferred refueling station. In some embodiments, the autonomous vehicle may receive fuel from the at least one automated fuel dispenser 600 of the preferred refueling station.

Additionally, the operations for method 900 can include determining an expected fuel mileage for the autonomous vehicle 100 based on the fuel level data. The operations for method 900 can additionally include selecting the preferred refueling station from the at least one candidate refueling station based on the expected fuel mileage.

In an embodiment, each of the one or more refueling stations of the system for automatic refueling of autonomous vehicles may comprise a first alignment lane 702a positioned on a first side of the refueling station. Additionally, each of the one or more refueling stations of the system for automatic refueling of autonomous vehicles may comprise a second alignment lane 702b positioned on a second side of the refueling station. The operation for method 900 can include identifying a selected alignment lane from the first alignment lane 702a and the second alignment lane 702b of the preferred refueling station based on a location of a reservoir inlet 114 of the autonomous vehicle 100.

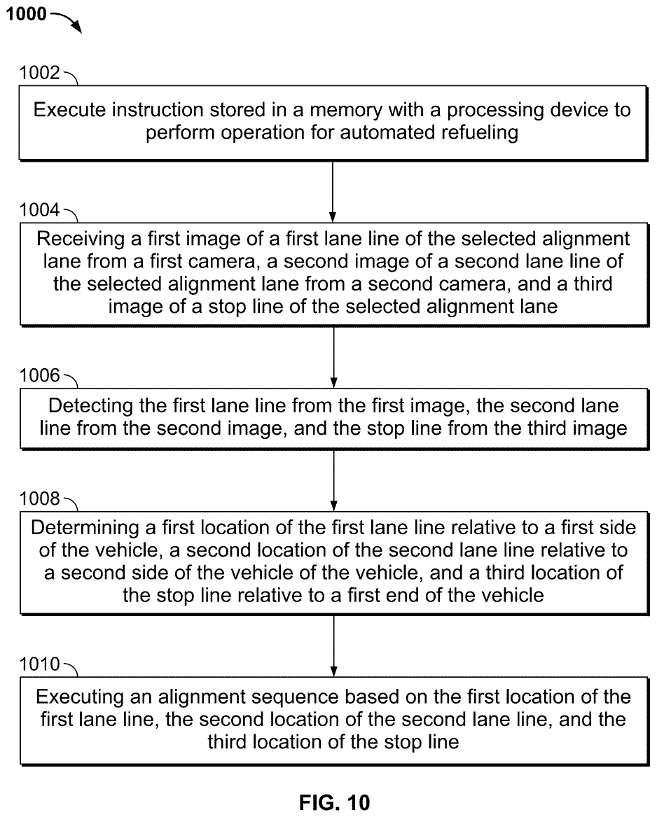

The operations for method 900 can include aligning the autonomous vehicle 100 with the at least one automated fuel dispenser 600 of the preferred refueling station using the selected alignment lane. Aligning the autonomous vehicle may comprise any of the operation described in FIG. 10 below.

FIG. 10 is a flowchart of an exemplary method 1000 for aligning an autonomous vehicle 100 with an automated fuel dispenser 600 for automated refueling of the autonomous vehicle 100 by the exemplary system 800 discussed herein. At 1002, a processing device (e.g., computing system 200, computing system 300, or the like) can execute instructions stored in a memory to perform operations for automated refueling. At 1004, the operations can include receiving a first image of a first lane line (e.g. first lane line 704a, second lane line 704b, or the like) of a selected alignment lane (e.g., alignment lane 702a, alignment lane 702b, or the like) from a first sensor (e.g. camera 214), a second image of a second lane line (e.g., first lane line 704a, second lane line 704b, or the like) of the selected alignment lane from a second sensor (e.g., camera 214), and a third image of a stop line of the selected alignment lane from a third sensor (e.g., camera 214). At 1006, the operations can include detecting the first lane line from the first image, the second lane line from the second image, and the stop line from the third image. At 1008, the operations can include determining a first location of the first lane line relative to a first side (e.g., a left side) of the autonomous vehicle, a second location (e.g., a right side) of the second lane line relative to a second side of the vehicle of the vehicle, and a third location of the stop line relative to a first end (e.g., a front end) of the vehicle. At 1010, the operations can include executing an alignment sequence based on the first location of the first lane line, the second location of the second lane line, and the third location of the stop line by the processing device to properly position a reservoir inlet (e.g., reservoir inlet 114) of the autonomous vehicle with an automated fuel dispenser (e.g., automated fuel dispenser 600).

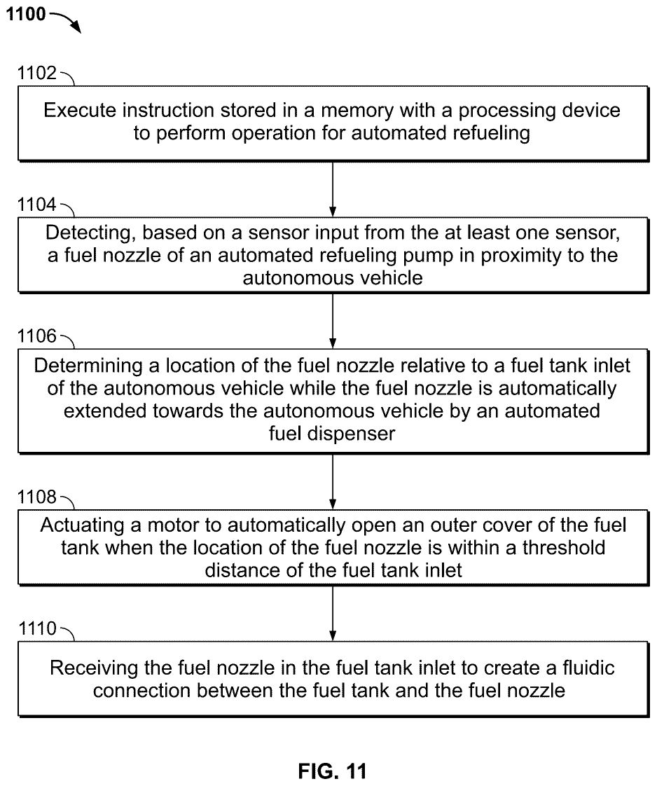

FIG. 11 is a flowchart of an exemplary method 1100 for automated refueling for autonomous vehicles by the exemplary system 800 discussed herein. At 1102, a processing device (e.g., computing system 200, computing system 300, or the like) can execute instructions stored in a memory to perform operations for automated refueling. At 1104, the operations can include detecting a fuel nozzle of an automated fuel dispenser (e.g., automated fuel dispenser 600) based on a sensor input from at least one sensor (e.g., sensor 202) of the autonomous vehicle. The automated fuel dispenser may be in close proximity (e.g., in a field of view of the at least one sensor) to the autonomous vehicle. At 1106, the operations can include determining a location of the fuel nozzle relative to a reservoir inlet (e.g., reservoir inlet 114) of a fuel reservoir of the autonomous vehicle. The location of the fuel nozzle may be continuously determined while the fuel nozzle is automatically extended towards the autonomous vehicle by an automated fuel dispenser (e.g., automated fuel dispenser 600). At 1108, the operations can include actuating a motor to automatically open an outer cover of the fuel reservoir when the location of the fuel nozzle is within a threshold distance of the reservoir inlet. At 1110, the method 1100 includes receiving the fuel nozzle in the reservoir inlet to create a fluidic connection between the fuel reservoir of the autonomous vehicle and fuel nozzle to allow the automated fuel dispenser to dispense fuel into the fuel reservoir through the hose (e.g., hose 604) and the fuel nozzle. At 1112, the method 1100 can include receiving fuel from the automated fuel dispenser through the hose and the fuel nozzle of the automated fuel dispenser.

Additionally, the operations for method 1100 can include determining the location of the fuel nozzle relative to the reservoir inlet while the fuel nozzle is automatically retracted from the autonomous vehicle by the automated fuel dispenser after refueling of the autonomous vehicle. The operations for method 1100 can additionally include actuating the motor to automatically close the outer cover of the fuel reservoir when the location of the fuel nozzle is greater than the threshold distance. In an embodiment, the location of the fuel nozzle may be determined based on a location of the at least one reference marker positioned on the fuel nozzle.

FIG. 12 is a flowchart of a second exemplary method 1200 for automated refueling for autonomous vehicles using an automated fuel dispenser by the exemplary system 800 discussed herein. The automated fuel dispenser may comprise a housing, a processing device located within the housing, a fuel hose coupled to the housing at a first end of the fuel hose, a fuel nozzle coupled to the fuel hose at a second end of the fuel hose, a first sensor mounted on a handle of the fuel nozzle, a linear rail system coupled to the housing, wherein the linear rail system is configured to enable the fuel nozzle to move along a first axis and a second axis, an extension arm coupled to the linear rail system, wherein the extension arm is configured to enable the fuel nozzle to move along a third axis. At 1202, the processing device can execute instructions stored in a memory to perform operations for automated refueling. At 1204, the operations can include detecting an autonomous vehicle proximal to the automated fuel dispenser based on a sensor input from the at least one sensor. At 1206, the operations can include extending the extension arm to extend the fuel nozzle towards the autonomous vehicle. At 1208, the operations can include operating the linear rail system to align the fuel nozzle with a reservoir inlet of a fuel reservoir of the autonomous vehicle. In some embodiments, operating the linear rail system may comprise adjusting a position of the fuel nozzle using the linear rail system based on the location of the reservoir inlet. At 1210, the operations can include detecting when the fuel nozzle is connected with the reservoir inlet. In some embodiments, detecting when the fuel nozzle is connected with the reservoir inlet may comprise receiving a signal from a second sensor disposed adjacent to a fuel outlet of the spout. At 1214, the operations can include initiating a motor to drive a fuel pump configured to enable a flow of fuel through the automated fuel dispenser, the fuel hose, and the fuel nozzle. At 1216, the operations can include operating the motor and the fuel pump to dispense fuel into the fuel reservoir to refuel the autonomous vehicle until a fuel level within the fuel reservoir reaches a threshold level.

In some embodiments, the operations for method 1200 can include retracting the extension arm to retract the fuel nozzle away from the autonomous vehicle when the fuel level reaches the threshold level.

Additionally, the operations for method 1200 can include determining a location of the reservoir inlet using the first sensor. In some embodiments, determining the location of the reservoir inlet can include detecting at least one reference marker positioned on an inner cover of the reservoir inlet using the first sensor and determining the location of the reservoir inlet based on the at least one reference marker using the processing device. In some embodiments, operating the linear rail system may comprise adjusting the position of the fuel nozzle along the first axis using a first linear rail of the linear rail system based on the location of the reservoir inlet. In some embodiments, operating the linear rail system comprises adjusting the position of the fuel nozzle along the second axis using a second linear rail of the linear rail system based on the location of the reservoir inlet.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for automated refueling of an autonomous vehicle, the autonomous vehicle comprising at least one sensor and a processing device communicatively connected to the at least one sensor, the method comprising:
executing instructions stored in a memory within the processing device to perform one or more operations comprising:
detecting, using an input from one of the at least one sensor, when a remaining fuel level for the autonomous vehicle is less than a threshold fuel level;
identifying a refueling station for refueling the autonomous vehicle;
controlling the navigation of the autonomous vehicle to locate the autonomous vehicle at the identified refueling station; and
further controlling the navigation of the autonomous vehicle to locate the autonomous vehicle in an alignment lane at the identified refueling station.

2. The method of claim 1, wherein further controlling the navigation of the autonomous vehicle to locate the autonomous vehicle in an alignment lane comprises selecting the alignment lane from a plurality of alignment lanes associated with the refueling station based on a location of a reservoir inlet for the autonomous vehicle after the autonomous vehicle arrives at the refueling station.

3. The method of claim 2, wherein further controlling the navigation of the autonomous vehicle to locate the autonomous vehicle in the alignment lane comprises:
receiving a first image of a first lane line of the selected alignment lane from a first camera, a second image of a second lane line of the selected alignment lane from a second camera, and a third image of a stop line of the selected alignment lane;
detecting the first lane line from the first image, the second lane line from the second image, and the stop line from the third image;
determining a first location of the first lane line relative to a first side of the autonomous vehicle, a second location of the second lane line relative to a second side of the autonomous vehicle, and a third location of the stop line relative to a first end of the autonomous vehicle; and
executing an alignment sequence based on the first location of the first lane line, the second location of the second lane line, and the third location of the stop line.

4. The method of claim 3, wherein the operations further comprise shutting off an engine of the autonomous vehicle.

5. The method of claim 4, wherein the operations further comprise determining a location of a fuel nozzle relative to a reservoir inlet of the autonomous vehicle, wherein the fuel nozzle is associated with an automated fuel dispenser located adjacent to the selected alignment lane.

6. The method of claim 5, wherein the operations further comprise actuating a motor to automatically open an outer cover of the reservoir inlet when the location of the fuel nozzle is within a threshold distance of the reservoir inlet.

7. The method of claim 6, wherein the operations further comprise actuating the motor to automatically close the outer cover of the reservoir inlet when the location of the fuel nozzle is within a threshold distance of the reservoir inlet.

8. A system for automated refueling of autonomous vehicles, the system comprising:
one or more refueling stations, each refueling station comprising at least one automated fuel dispenser configured to dispense fuel during refueling of vehicles; and
a fuel sensor and a processing device associated with an autonomous vehicle in communication with the fuel sensor, wherein the processing device is configured to execute instructions stored in a memory to perform operations comprising:
detecting, using an input from the fuel sensor, when a remaining fuel level for the autonomous vehicle is less than a threshold fuel level;
identifying at least one candidate refueling station from the one or more refueling stations;
selecting a preferred refueling station from the at least one candidate refueling station;
controlling the navigation of the autonomous vehicle to the preferred refueling station; and
further controlling the navigation of the autonomous vehicle to locate the autonomous vehicle in an alignment lane at the preferred refueling station.

9. The system of claim 8, wherein the operations further comprise determining an expected travel mileage for the autonomous vehicle based on the remaining fuel level and fuel efficiency data for the autonomous vehicle.

10. The system of claim 9, wherein identifying at least one candidate refueling station from the one or more refueling stations comprises filtering the at least one candidate refueling station using the expected travel mileage.

11. The system of claim 8, wherein each refueling station further comprises a first alignment lane positioned on a first side of the refueling station.

12. The system of claim 11, wherein each refueling station further comprises a second alignment lane positioned on a second side of the refueling station.

13. The system of claim 12, wherein further controlling the navigation of the autonomous vehicle to locate the autonomous vehicle in the alignment lane comprises selecting the alignment lane from the first alignment lane and the second alignment lane of the preferred refueling station based on a location of a reservoir inlet of the autonomous vehicle.

14. The system of claim 13, wherein further controlling the navigation of the autonomous vehicle to locate the autonomous vehicle in an alignment lane comprises:
receiving a first image of a first lane line of the selected alignment lane from a first camera, a second image of a second lane line of the selected alignment lane from a second camera, and a third image of a stop line of the selected alignment lane;
detecting the first lane line from the first image, the second lane line from the second image, and the stop line from the third image;
determining a first location of the first lane line relative to a first side of the autonomous vehicle, a second location of the second lane line relative to a second side of the autonomous vehicle, and a third location of the stop line relative to a first end of the autonomous vehicle; and
executing an alignment sequence based on the first location of the first lane line, the second location of the second lane line, and the third location of the stop line.

15. The system of claim 14, wherein the operations further comprise shutting off an engine of the autonomous vehicle.

16. The system of claim 8, wherein the operations further comprise updating a mission procedure for the autonomous vehicle with the preferred refueling station.

17. A method for automated refueling of an autonomous vehicle, the autonomous vehicle comprising at least one sensor and a processing device communicatively connected to the at least one sensor, the method comprising:
executing instructions stored in a memory with a processing device in communication with the one or more sensors to perform operations comprising:
detecting, based on an input from the at least one sensor, a fuel nozzle of an automated fuel dispenser in proximity to the autonomous vehicle;
determining a location of the fuel nozzle relative to a reservoir inlet of the autonomous vehicle while the fuel nozzle is automatically extended towards the autonomous vehicle by an automated fuel dispenser; and
actuating a motor to automatically open an outer cover of the reservoir inlet when the location of the fuel nozzle is within a threshold distance of the reservoir inlet; and
receiving the fuel nozzle in the reservoir inlet to create a fluidic connection between the fuel reservoir and the fuel nozzle.

18. The method of claim 17, wherein the operations further comprise determining the location of the fuel nozzle relative to the reservoir inlet while the fuel nozzle is automatically retracted from the autonomous vehicle by the automated fuel dispenser after refueling of the autonomous vehicle.

19. The method of claim 18, wherein the operations further comprise actuating the motor to automatically close the outer cover of the reservoir inlet when the location of the fuel nozzle is greater than the threshold distance.

20. The method of claim 19, wherein determining the location of the fuel nozzle comprises determining the location of the fuel nozzle based on at least one reference marker positioned on the fuel nozzle.
